(19) United States
(12) Patent Application Publication
(10) Pub. No.: US 2009/0144332 A1
(43) Pub. Date: Jun. 4, 2009

(54) SIDEBAND ACCESS BASED METHOD AND APPARATUS FOR DETERMINING SOFTWARE INTEGRITY

(76) Inventor: Wallace Paul Montgomery, Austin, TX (US)

Correspondence Address: ZAGORIN O'BRIEN GRAHAM LLP, 7600B NORTH CAPITAL OF TEXAS HIGHWAY, SUITE 350, AUSTIN, TX, 78731, US

(21) Appl. No.: 11/947,330

(22) Filed: Nov. 29, 2007

(51) Int. Cl. G06F 12/00

(52) U.S. Cl. 707/200

(57) ABSTRACT

A management controller supplies a processor with a command via a sideband interface on the processor. Responsive to the command, the processor reads storage locations accessible by the processor and supplies the contents of the storage locations to the management controller via the sideband interface. The management controller then evaluates the integrity of software associated with the storage locations by comparing a digital signature associated with the software to a known digital signature.

### BACKGROUND

1. Field of the Invention

This application relates to determining software integrity in computer systems and more particular to determining software integrity in a secure and reliable manner using techniques less likely to be targeted by and more resilient to malicious software attacks.

2. Description of the Related Art

As the number of malicious software attacks continues to rise, the information technology (IT) industry must place more resources into finding ways to stop the attacks. One of the most common methods of preventing malicious software attacks is the use of virus and worm scanner software. A problem with this approach is that the virus and worm scanning software may themselves be the target (and have in the past) of malicious software attacks and become an agent of spreading the malicious software. Detecting this type of malicious attack is extremely difficult because the malicious software now controls the reporting mechanism. This type of attack is potentially very dangerous as the virus/worm scanner typically can access nearly every file in the file system during normal operation at which time new infections can be initiated widely on the system.

In virtualization technology, whose use is rapidly expanding, a new type of super trusted software call a hypervisor resides between the operating system(s) and system hardware. The hypervisor may be undetectable to the operating system and inaccessible to any type of traditional malicious software detection mechanism. However, studies and demonstrations have shown the hypervisor to also be a potential target for malicious software attacks.

Additionally, as hypervisor usage becomes more common to support server consolidation, the hypervisor itself becomes a new single point of failure. Because the hypervisor resides between the operating system(s) and the hardware, there is no good way to measure the health of the hypervisor from normal software. If the hypervisor fails, the monitoring software will be disabled as well.

### SUMMARY

Accordingly, a new approach to determining software integrity, both its health generally and also with respect to possible attack, is provided while remaining outside of a software attack vector. Use of the new approach can provide increased platform security and reliability.

In an embodiment, a method is provided in which management controller supplies a processor with a command via a sideband interface on the processor. Responsive to the command, the processor reads storage locations accessible by the processor and supplies the contents of the storage locations to the management controller via the sideband interface. The management controller then evaluates the integrity of software associated with the storage locations by comparing a digital signature associated with the software to a known digital signature.

In another embodiment, a computer system is provided that includes a processor having a sideband interface and storage coupled to the processor. A management controller is coupled to the processor through the sideband interface. The processor includes a microcode engine responsive to communication from the sideband interface to cause the processor to read data from storage locations in the storage and provide the data to the management controller through the sideband interface. The data is associated with the software to be evaluated. The management controller is responsive to the data received from the processor to determine integrity of the software associated with the data read from the storage by comparing a digital signature determined from the data and a known digital signature.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a high level block diagram of an exemplary computer system according to an embodiment of the invention.

FIG. 2 illustrates additional details of an exemplary system.

FIG. 3 illustrates additional details of the system of FIG. 2.

FIG. 4A illustrates a flow diagram of using a management controller and a sideband interface to evaluate integrity of software according to an embodiment of the invention.

FIG. 4B illustrates another embodiment of a flow diagram showing evaluation of software integrity using a management controller and a sideband interface.

Note that the use of the same reference symbols in different drawings indicates similar or identical items.

### DESCRIPTION OF THE PREFERRED EMBODIMENT(S)

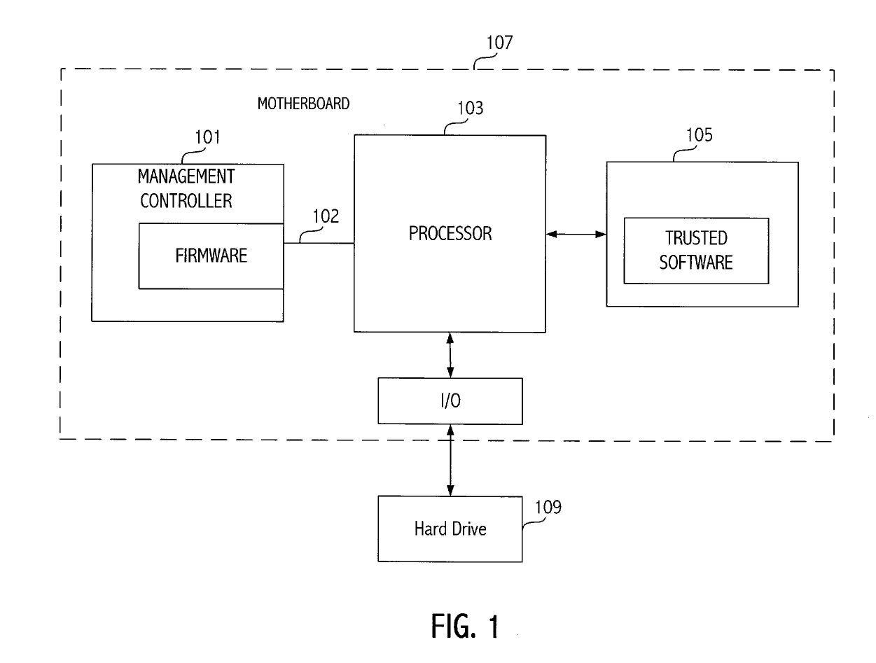

Referring to FIG. 1, illustrated is a high level block diagram of an exemplary computer system according to an embodiment of the invention. A management controller 101 includes appropriate software/firmware to communicate with processor 103 and perform appropriate management functions. One type of system management controller is known in the art as a baseboard management controller (BMC). BMC's are microcontrollers typically residing on the motherboard of servers, and are coupled to various system sensors. The BMC manages such system functions as temperature, fan speed, power, etc. The BMC provides an interface between system management software and platform hardware. However, in traditional BMC architectures there has been no direct connection to the processor and only a connection to the sensors described above.

In contrast, as shown in FIG. 1, the system management controller, according to an embodiment of the invention, includes a communication link 102 directly connecting the management controller 101 to processor 103. The processor 103 is coupled to memory storage 105. In an embodiment, memory storage 105 is DRAM storing a variety of system software executing on the system. In another embodiment, memory 105 may be non-volatile memory storing a boot image. Thus, the trusted software 107 may be a wide variety of software that runs on the system of FIG. 1, such as operating system software, hypervisor software, virus and worm scanning software (generally threat detection software). The software may reside on the motherboard 107, e.g., in RAM or non-volatile memory. The connection to the physical location 105 storing the trusted software may be direct or indirect. Alternatively, the software may be available to the processor via an input/output port, which may be coupled to one or more hard drives 109 storing software whose integrity is to be measured by the management controller.

The system of FIG. 1 allows a platform, i.e., the management controller 101, that is substantially independent of processor 103 and its trusted software, to measure the integrity of the trusted software.

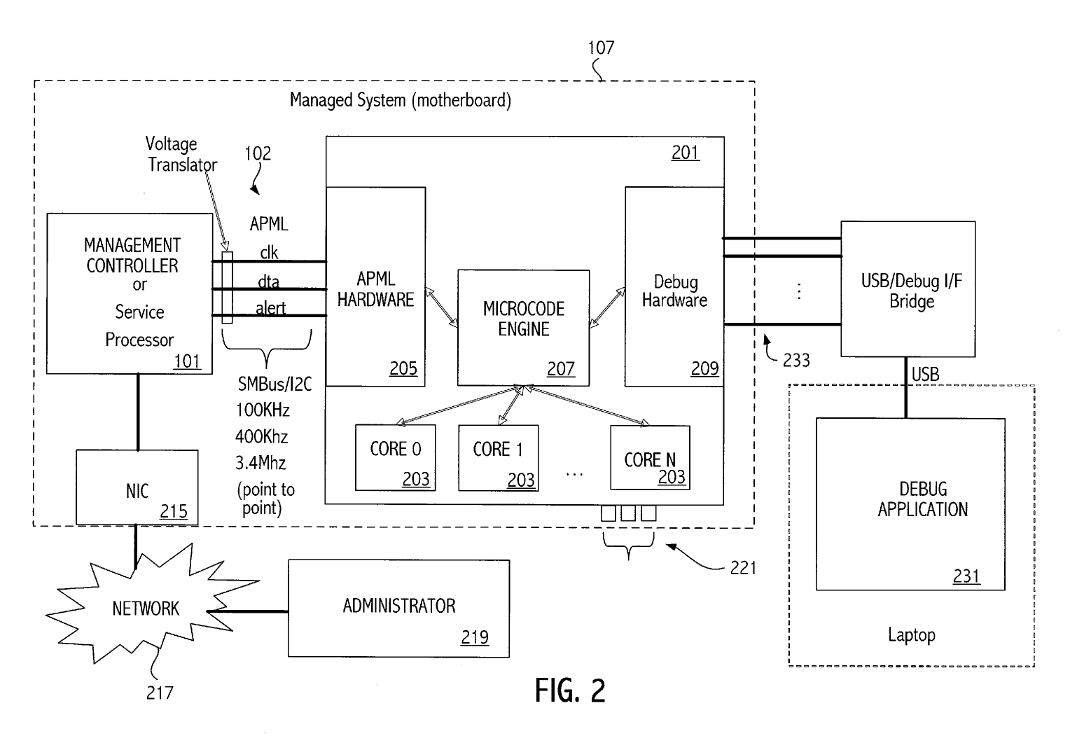

Referring now to FIG. 2, an embodiment of the invention is shown in greater detail. The management controller or service processor 101 is coupled via an Advanced Platform Management Link (APML) 102 to an exemplary APML enabled processor 201. APML processor 201 includes multiple cores 203. APML processor 201 includes APML hardware 205, microcode engine 207 and debug hardware 209.

In an embodiment, the communication link (APML) 102 includes clock, data, and an alert signal line. The alert signal line allows the processor to signal the management controller of the occurrence an event. The link 102 may be a point-to-point link between the management controller 101 and the processor 201. The link may be an SMBus or other communication link and may run at various frequencies, e.g., 100 KHz, 400 KHz, 3.4 MHz, or other clock frequency suitable for the particular application. The communication link 102 is used to supply the APML hardware with commands and data and to retrieve data associated with the command, e.g., as a result of a read operation, and provide that data to the management controller 101 for evaluation.

The management controller 101 may be coupled through a network interface card (NIC) 215 to network 217 and through network 217 to an administrator 219. The administrator can provide the management controller 101 with information related to processor 201 through the network as described further herein. The administrator can utilize APML's capabilities to read/write processor state over the network.

The processor 201 includes three address pins 221 that allow the link 102 to select up to eight different processors on a single APML bus segment.

FIG. 2 also shows debug interface 209 coupled to a debug application 231, through a debug bus 233, which may be implemented as a JTAG bus with additional signal lines DBReq and DBRdy. Such an interface is known in the art and implemented, e.g., by Advanced Micro Devices Hardware Debug Tool (HDT).

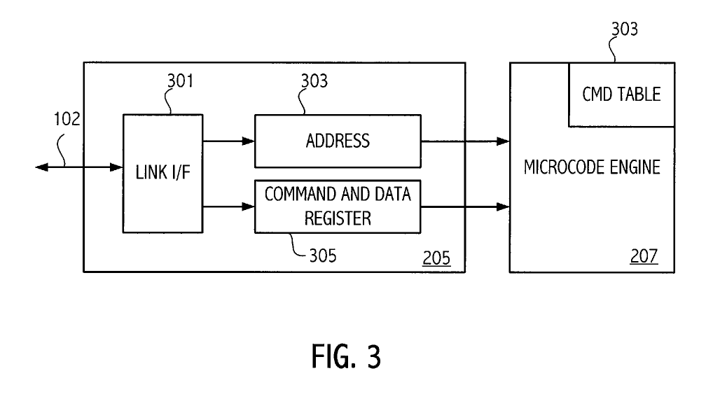

Referring to FIG. 3, additional details of the APML block 205 is shown. APML block 205 includes a link interface 301 that implements the protocol necessary to communicate over the link 102. In addition, APML block 205 includes an address register and a command and data register. The address register 303 stores address information sent over the link 102. The command and data register 305 stores command information and data, if appropriate for the particular command, e.g., data associated with a write command. In addition, the command and data register receives data from the microcode engine in response to an executed command, e.g., data read from a particular location in the processor or external to the processor.

The microcode engine 207 receives the commands from the APML block 205 and executes those commands while the microprocessor maintains normal operation. The microcode engine, which is conventional, executes the APML commands at appropriate instruction boundaries of regular instructions executed by the microprocessor. The APML commands function similarly to an interrupt mechanism in that the normal flow of microprocessor instructions is halted briefly while the microcode executes the APML command and then the normal microprocessor instructions resume execution at the conclusion of the APML command.

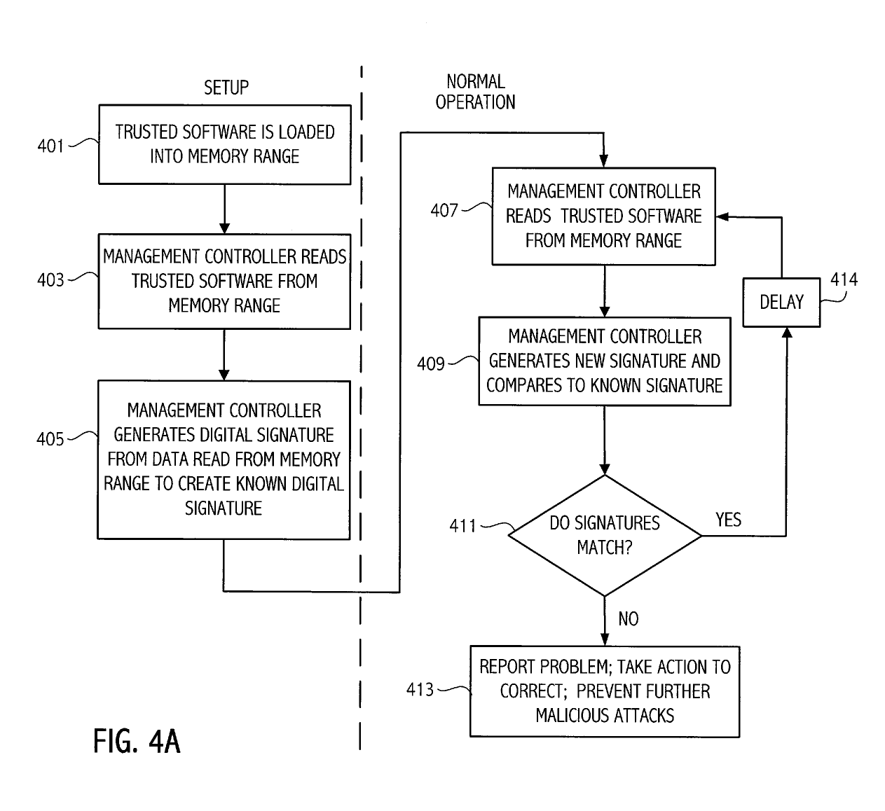

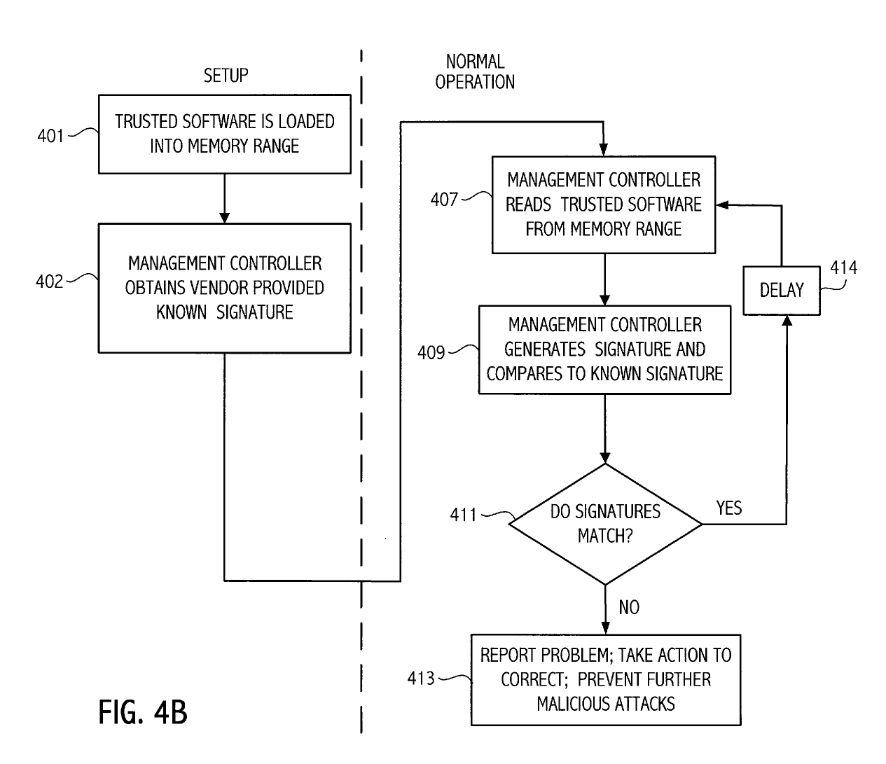

Referring now to FIG. 4A, a flow diagram illustrates one embodiment of using a management controller and a sideband interface to evaluate integrity of software that may be associated with a hypervisor, operating system, or other aspect of the computer platform. During setup, in 401, the trusted software is loaded into a memory range. For example, operating system, hypervisor, virus scan, or other trusted software may be loaded into system memory as part of system initialization on boot-up. In other embodiments, the trusted software whose integrity is to be tested may be stored in non-volatile memory. The management controller may be informed of the location of the trusted software whose integrity is to be verified by the administrator 219 over the network 217. The location may be predetermined for the particular type of software to be verified.

In one embodiment, in order to obtain an appropriate digital signature for comparison, the management controller reads the trusted software (or a subset thereof) from an appropriate range of system memory in 403. That memory range may be a subset of the entire memory range of the trusted software that is sufficient to ensure the integrity of the trusted software. The management controller reads the trusted software (or portion thereof) by sending an appropriate command over the sideband interface, which causes the processor in response to read storage locations accessible by the processor and provide the data in the storage locations to the management controller. The management controller can then generate a digital signature of the software according to an appropriate encryption algorithm for later use. In other embodiments, a digital signature is provided to the management controller by the administrator over the network. That digital signature provided by the administrator may come from the vendor of the software being monitored.

During normal system operation, at 407 the management controller reads trusted software from the memory range containing the software to be analyzed by sending appropriate commands through the sideband interface to the processor. At 409 the management controller generates a digital signature from the software that was read and evaluates the integrity of software associated with the memory range by comparing the digital signature to a known signature, either previously generated by the management controller, provided to the management controller through the network, or otherwise obtained by the management controller. The digital signature may be generated by a hash algorithm or other appropriate encryption algorithm. In 411, the digital signatures are compared. If the signatures do not match, in 413 the management controller may report the problem to the administrator, take action to correct, and/or take action to prevent further malicious attacks. If the signatures match, the flow returns to 407 where the management controller can again read the trusted software from the appropriate memory range.

In an embodiment, the management controller periodically evaluates the integrity of trusted software and thus may return to 407 on a periodic basis through a delay 414. The frequency with which the management controller evaluates the trusted software may be programmable. Thus, the length of the delay 414 can be programmable. As stated earlier, the trusted software may be resident in system memory, on an I/O device such as a hard drive, or on non-volatile memory within the system. The trusted software may be a hypervisor, operating system software, virus/worm scanner, firewall software, or manageability software, or any other software whose integrity it would be beneficial for the management controller to ascertain and/or monitor. This approach to evaluating the health of the software allows evaluation of operating system or hypervisor software during runtime that may be otherwise difficult to evaluate if it becomes unhealthy. It further allows evaluating the integrity using a mechanism that is less likely to be the target of a malicious software attack and is more resilient to attack. Note that while FIG. 4A is specifically directed to trusted software, such as operating system or threat detection software, the approach is generally applicable to all software running on the system whose integrity would be advantageous to check. Referring to FIG. 4B, another embodiment is illustrated in which the management controller obtains a vendor provided known signature in 402 and then begins the operational process shown in 401 to 414.

The description of the invention set forth herein is illustrative, and is not intended to limit the scope of the invention as set forth in the following claims. Other variations and modifications of the embodiments disclosed herein may be made based on the description set forth herein, without departing from the scope and spirit of the invention as set forth in the following claims.

What is claimed is:

1. A method comprising:
supplying a processor from a management controller via a sideband interface on the processor with a command;
responsive to the command, the processor reading storage locations accessible by the processor and supplying contents of the storage locations to the management controller via the sideband interface;
evaluating integrity of software associated with the storage locations by comparing a digital signature associated with the software to a known digital signature.

2. The method as recited in claim 1 further comprising the management controller generating the digital signature associated with the software using the contents of the storage locations supplied by the processor.

3. The method as recited in claim 1, wherein the evaluating is performed by the management controller.

4. The method as recited in claim 3, further comprising:
the management controller periodically evaluating integrity of the software associated with the storage locations.

5. The method as recited in claim 1, wherein the storage locations are in volatile memory.

6. The method as recited in claim 1, wherein the storage locations are in non-volatile memory.

7. The method as recited in claim 1, wherein the software is trusted software.

8. The method as recited in claim 1, further comprising:
the management controller determining the known digital signature by causing the processor in response to another command sent via the sideband interface, earlier than the command, to read the memory locations and supply contents thereof to the management controller via the sideband interface; and
determining the known digital signature according to an encryption algorithm.

9. The method as recited in claim 8, further wherein the digital signature and the known digital signature are determined using a hash algorithm.

10. The method as recited in claim 7, further comprising reading a subset of the trusted software to evaluate the integrity of the trusted software.

11. The method as recited in claim 1, wherein the software is one of a hypervisor, virus/worm scanner, firewall software, or manageability software.

12. An apparatus comprising:
a processor including a sideband interface;
a storage coupled to the processor;
a management controller coupled to the processor through the sideband interface;
the processor including a microcode engine responsive to communication from the sideband interface to cause the processor to read data from storage locations in the storage and provide the data to the management controller through the sideband interface, the data associated with software to be evaluated;
the management controller responsive to the data received from the processor to determine integrity of the software associated with the data read from the storage.

13. The apparatus as recited in claim 12 wherein the management controller is responsive to receipt of the data from the processor to compare a known digital signature associated with the software to another digital signature derived from the data to determine integrity of the trusted software.

14. The apparatus as recited in claim 12 wherein the known digital signature is determined by an earlier read of the data.

15. The apparatus as recited in claim 12 wherein the known digital signature is provided to the management controller via a network connection.

16. The apparatus as recited in claim 12, wherein the digital signature and the known digital signature are determined using a hash algorithm.

17. The apparatus as recited in claim 12, wherein the management controller is configured to cause the processor to reread the trusted software location on a periodic basis to determine software integrity of the trusted software.

18. The apparatus as recited in claim 12, wherein the software is one of a hypervisor, operating system software, virus/worm scanner software, firewall software, and manageability software.
